(19) United States
(12) Patent Application Publication
(10) Pub. No.: US 2008/0225464 A1
(43) Pub. Date: Sep. 18, 2008

(54) Supercapacitors and Methods of Manufacturing Same

(75) Inventor: David S. Lashmore, Lebanon, NH (US)

Correspondence Address: GREENBERG TRAURIG, LLP, ONE INTERNATIONAL PLACE, 20th FL, ATTN: PATENT ADMINISTRATOR, BOSTON, MA, 02110, US

(73) Assignee: Nanocomp Technologies, Inc.

(21) Appl. No.: 12/044,746

(22) Filed: Mar. 7, 2008

Related U.S. Application Data
(60) Provisional application No. 60/905,709, filed on Mar. 8, 2007.

(51) Int. Cl. H01G 9/012; D01F 9/12; B32B 37/00

(52) U.S. Cl. 361/502; 423/447.2; 156/281; 29/25.03

(57) ABSTRACT

A capacitor is provided. The capacitor includes opposing electrodes fabricated from a non-woven carbon nanotube sheet bonded to opposing noble metal foils. The capacitor also includes a non-porous casing within which the opposing electrodes are placed. The capacitor further includes electrically conductive contacts extending from the noble metal foils through an opening in the casing. The capacitor can be a portable capacitor. A method of manufacturing the capacitor is also provided.

### RELATED U.S. APPLICATION(S)

The present application claims priority to U.S. Provisional Application Ser. No. 60/905,709, filed Mar. 8, 2007, which application is hereby incorporated herein by reference.

### TECHNICAL FIELD

The present invention relates to capacitors, and more particularly, to lightweight supercapacitors manufactured from at least one non-woven sheet of carbon nanotubes, and to a method of attaching the non-woven sheet to a conductive electrode.

### BACKGROUND ART

Supercapacitors based on electrochemical type charge storage have been around for several years and have been extensively reviewed. Applications for these supercapacitors include load leveling, supplementing batteries for peak power demands, energy storage in regenerative drive systems, and a variety of high power applications. In addition, specific capacitance for such super-capacitors can potentially exceed 1000 F/g, while energy density can be greater that 12.5 kW/kg. As a result, super-capacitors can be used in applications where weight and volume are at a premium. Examples may include pulse de-icing of aircraft wings, rail guns, portable batteries, high power applications where weight is an issue, and signal conditioning where capacitor volume is an issue.

Of interest, significantly low temperature does not appreciably affect performance of a super-capacitor. In addition, with advances in organic electrolytes, and reductions in the diameters of the carbon nanotube, it is possible that super-capacitors potentially may replace batteries. Electrolytic carbon nanotube supercapacitors, based on organic electrolyte technology, have a distinct cost advantage over existing electrochemical capacitors, such as those containing RuO₂. In particular, they can be fully discharged, and yet their specific power far exceeds battery capability. Moreover, charging and discharging efficiency of these organic-based capacitors are over 90%. Furthermore, they require little or no maintenance and can exhibit an indefinite number of charge discharge cycles.

However, the disadvantages of this type of capacitor include (1) the high cost of existing nanotube material, (2) relatively low performance, (3) the need to use an organic electrolyte with a high breakdown voltage, (4) the relatively low overall capacitor voltage so that contact resistance must be extremely low to extract the high power required for some demanding applications, and (5) the electrolyte must be carefully packaged, so as to remain free of trace amounts of water.

Carbon nanotubes are known to have extraordinary tensile strength, including high strain to failure and relatively high tensile modulus. Carbon nanotubes may also be highly electrically conductive while being resistant to fatigue, radiation damage, and heat.

Within the last fifteen (15) years, as the properties of carbon nanotubes have been better understood, interests in carbon nanotubes have greatly increased within and outside of the research community. One key to making use of these properties is the synthesis of nanotubes in sufficient quantities for them to be broadly deployed. For example, large quantities of carbon nanotubes may be needed if they are to be used as high strength components of composites in macroscale structures (i.e., structures having dimensions greater than 1 cm.)

One common route to nanotube synthesis can be through the use of gas phase pyrolysis, such as that employed in connection with chemical vapor deposition. In this process, a nanotube may be formed from the surface of a catalytic nanoparticle. Specifically, the catalytic nanoparticle may be exposed to a gas mixture containing carbon compounds serving as feedstock for the generation of a nanotube from the surface of the nanoparticle.

Recently, one promising route to high-volume nanotube production has been to employ a chemical vapor deposition system that grows nanotubes from catalyst particles that “float” in the reaction gas. Such a system typically runs a mixture of reaction gases through a heated chamber within which the nanotubes may be generated from nanoparticles that have precipitated from the reaction gas. Numerous other variations may be possible, including ones where the catalyst particles may be pre-supplied.

In cases where large volumes of carbon nanotubes may be generated, however, the nanotubes may attach to the walls of a reaction chamber, resulting in the blockage of nanomaterials from exiting the chamber. Furthermore, these blockages may induce a pressure buildup in the reaction chamber, which can result in the modification of the overall reaction kinetics. A modification of the kinetics can lead to a reduction in the uniformity of the material produced.

An additional concern with nanomaterials may be that they need to be handled and processed without generating large quantities of airborne particulates, since the hazards associated with nanoscale materials are not yet well understood.

The processing of nanotubes or nanoscale materials for macroscale applications has steadily increased in recent years. The use of nanoscale materials in textile fibers and related materials has also been increasing. In the textile art, fibers that are of fixed length and that have been processed in a large mass may be referred to as staple fibers. Technology for handling staple fibers, such as flax, wool, and cotton has long been established. To make use of staple fibers in fabrics or other structural elements, the staple fibers may first be formed into bulk structures such as yarns, tows, or sheets, which then can be processed into the appropriate materials.

Accordingly, it would be desirable to provide a material that can take advantage of the characteristics and properties of carbon nanotubes, so that a high performance super-capacitor can be manufactured quickly, in large volume, and in a cost-effective manner, while having optimized organic electrolytes, as well as other cell parameters to so that high power and high capacitance can be generated.

### SUMMARY OF THE INVENTION

The present invention, in one embodiment, provides a super-capacitor for a variety of energy and power related applications. The super-capacitor includes opposing electrodes, each having an electrically conducting substrate. In an embodiment, each opposing substrate may be a foil or sheet of aluminum, silver, gold, copper, graphfoil, graphite, semiconductors or other similar electrically conducting materials. The super-capacitor may also include a non-woven carbon nanotube sheet bonded to each of the opposing substrates. The non-woven sheet, in one embodiment, may be made from single wall carbon nanotubes and/or multi-wall carbon nanotubes. The bonding material, on the other hand, may be a glassy carbon precursor, such as RESOL resin or malic acid catalyzed furfuryl alcohol. The super-capacitor further includes a casing within which the substrates and the non-woven sheets are situated. In an embodiment, the casing may be made from any non-reactive material, such as a polymer similar to polypropylene, polyethylene, or a combination thereof. An electrically conductive contact may also be provided, extending from one or both of the opposing electrodes through an opening in the casing. To reduce resistance, the contacts may be plated with an electroconductive material, such as gold or silver. This supercapacitor may also be portable.

In another embodiment, the supercapacitor may be provided as above without the electrically conductive contact. In this embodiment, a set of bipolar electrode may be included, independent of the other two electrodes. Such a bipolar electrode can provide a bipolar effect, such that there appears to be a virtual anode and cathode for cases where it may be difficult to contact the opposing foil electrodes directly.

The present invention further provides in another embodiment a method for manufacturing a super-capacitor from a nano-fibrous non-woven sheet. The method includes coating a sheet of aluminum foil with an thin layer of adhesive glassy carbon material, such as RESOL resin or furfuryl alcohol. Next, a nanofibrous non-woven sheet may be bonded to the aluminum foil. In an embodiment, the bond step may include slowly pyrolyzing the glassy carbon material from about 200° C. to about 1500° C., and preferably over about 450° C., in an inert atmosphere to form a thin glassy carbon bonding layer. The formed electrolytes may thereafter be assembled into a thin film capacitor by placing a hydrophilic polypropylene porous membrane or other porous membranes between the electrodes, and securing the pair of electrodes in a non-porous polypropylene package. The joints may subsequently be thermally sealed, while allowing for a small opening for filling the package with an electrolyte.

### BRIEF DESCRIPTION OF DRAWINGS

FIGS. 1-2 illustrate a system for formation and harvesting of nanofibrous non-woven materials in accordance with one embodiment of the present invention.

FIG. 2A illustrates an alternate system for formation and harvesting of nanofibrous non-woven materials in accordance with an embodiment of the present invention.

FIG. 3 illustrate a nanofibrous non-woven sheet generated from the system shown in FIGS. 1-2, and from which capacitor electrodes can be fabricated.

FIG. 4 illustrates voltammetry curves at different scan rates for the same nanofibrous non-woven sheet.

FIG. 5 illustrates an overall capacitance for three different electrodes fabricated under different conditions from nanofibrous non-woven sheets.

FIG. 6 illustrates a specific capacitance in F/g for three different electrodes, each fabricated from a nanofibrous non-woven sheet manufactured with different growth conditions.

FIGS. 7A-C illustrate a correlation of the structure of the three nanofibrous non-woven sheets shown in FIG. 6.

FIG. 8 illustrates, in an embodiment, a super-capacitor of the present invention.

FIG. 9 illustrates the charging characteristics of a super-capacitor of the present invention.

FIG. 10 illustrates a diameter histogram for three different types of non-woven carbon nanotube sheets.

FIG. 11 illustrates an estimate of the performance of the super-capacitor of the present invention in comparison to other types of power storage systems.

FIG. 12 illustrates a super-capacitor in accordance with another embodiment of the present invention.

### DESCRIPTION OF SPECIFIC EMBODIMENTS

Nanotubes for use in connection with the present invention may be fabricated using a variety of approaches. Presently, there exist multiple processes and variations thereof for growing nanotubes. These include: (1) Chemical Vapor Deposition (CVD), a common process that can occur at near ambient or at high pressures, and at temperatures of about 400° C. or above, (2) Arc Discharge, a high temperature process that can give rise to tubes having a high degree of perfection, and (3) Laser ablation. It should be noted that although reference is made below to nanotube synthesized from carbon, other compound(s) may be used in connection with the synthesis of nanotubes for use with the present invention. Other methods, such as plasma CVD or the like are also possible.

The present invention, in one embodiment, employs a CVD process or similar gas phase pyrolysis procedures well known in the industry to generate the appropriate nanotubes. In particular, since growth temperatures for CVD can be comparatively low ranging, for instance, from about 400° C. to about 1400° C., carbon nanotubes, both single wall (SWNT) or multiwall (MWNT), may be grown, in an embodiment, from nanostructural catalyst particles introduced into reagent carbon-containing gases (i.e., gaseous carbon source), either by addition of existing particles or by in situ synthesis of the particles from a metal-organic precursor, or even non-metallic catalysts. Although both SWNT and MWNT may be grown, in certain instances, SWNT may be preferred.

Moreover, the strength of the SWNT and MWNT generated for use in connection with the present invention may be about 30 GPa or more. Strength, as should be noted, is sensitive to defects. However, the elastic modulus of the SWNT and MWNT fabricated for use with the present invention is typically not sensitive to defects and can vary from about 1 to about 1.5 TPa. Moreover, the strain to failure, which generally can be a structure sensitive parameter, may range from a few percent to a maximum of about 10% in the present invention.

Furthermore, the nanotubes of the present invention can be provided with relatively small diameter, so that relatively high capacitance can be generated. In an embodiment of the present invention, the nanotubes of the present invention can be provided with a diameter in a range of from less than 1 nm to about 10 nm. It should be appreciated that the smaller the diameter of the nanotubes, the higher the surface area per gram of nanotubes can be provided, and thus the higher the capacitance that can be generated. For example, assuming a 50 micron Farads per cm capacitance for graphene and a density of about 1.5 g/cc for the SWNT, capacitance can be calculated using the following formula:

Capacitance (Farads/gram)=1333/d(nm)

Therefore, assuming a uniform textile of 1 nm diameter tubes with no shielding, then a specific capacitance of 1333 Farads per gram should be feasible

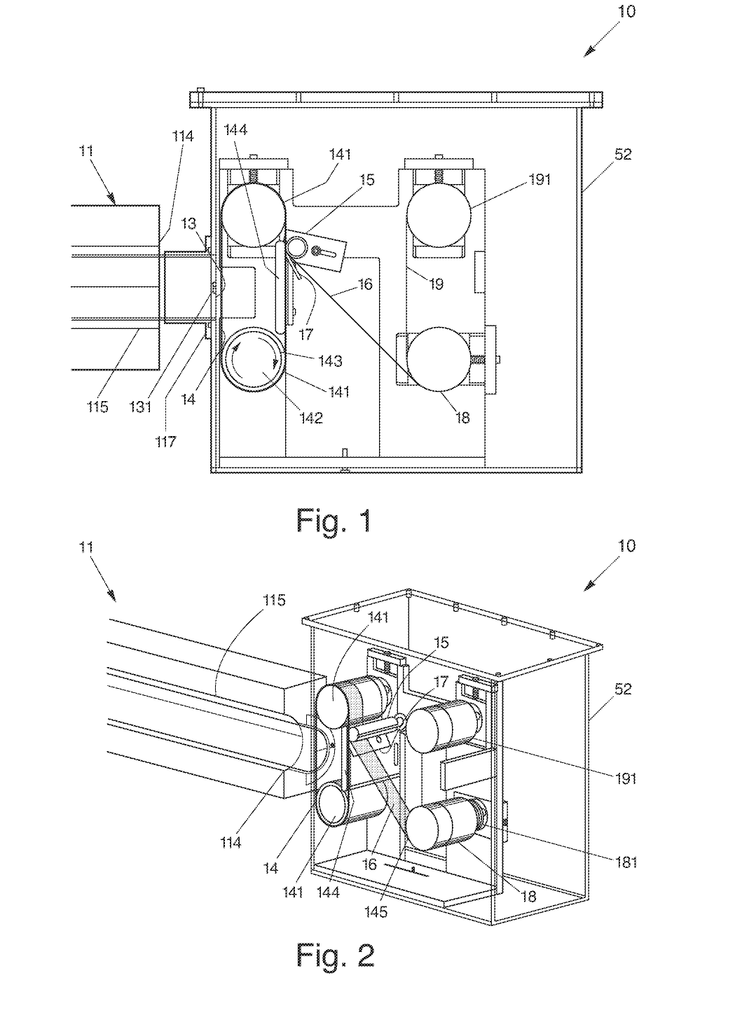

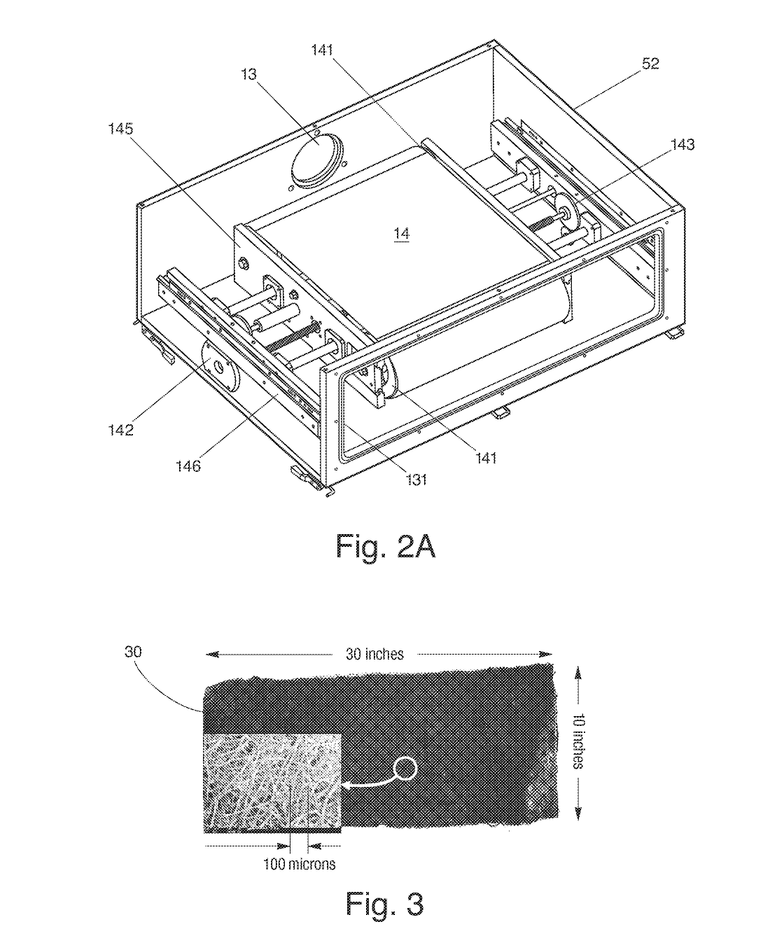

Referring now to FIGS. 1, 2 and 2A, there is illustrated, in accordance with one embodiment of the present invention, a system 10 for collecting synthesized nanotubes made from a CVD process within a synthesis chamber 11, and for subsequently forming bulk fibrous structures or materials from the nanotubes. In particular, system 10 may be used in the formation of a substantially continuous non-woven sheet generated from compacted and intermingled nanotubes and having sufficient structural integrity to be handled as a sheet.

System 10, in an embodiment, may be coupled to a synthesis chamber 11. Synthesis chamber 11, in general, includes an entrance end, into which reaction gases may be supplied, a hot zone, where synthesis of extended length nanotubes may occur, and an exit end 114 from which the products of the reaction, namely the extended length nanotubes and exhaust gases, may exit and be collected. In one embodiment, synthesis chamber 11 may include a quartz or ceramic tube 115, extending through in a furnace and may include flanges 117 provided at exit end 114 and entrance end for sealing tube 115. Although illustrated generally in FIG. 1, it should be appreciated that other configurations may be employed in the design of synthesis chamber 11. For example, a preheater (not shown), may be positioned at the entrance end into the tube 115 to better control the in situ formation of catalyst particles.

System 10, in one embodiment of the present invention, includes a housing 52. Housing 52, as illustrated in FIG. 1, may be substantially airtight to minimize the release of potentially hazardous airborne particulates from within the synthesis chamber 11 into the environment, and to prevent oxygen from entering into the system 10 and reaching the synthesis chamber 11. In particular, the presence of oxygen within the synthesis chamber 11 can affect the integrity and compromise the production of the nanotubes.

System 10 may also include an inlet 13 for engaging the flanges 117 at exit end 114 of synthesis chamber 11 in a substantially airtight manner. In one embodiment, inlet 13 may include at least one gas exhaust 131 through which gases and heat may leave the housing 52. Gas exiting from exhaust 131, in an embodiment, may be allowed to pass through a liquid, such as water, or a filter to collect nanomaterials not gathered upstream of the exhaust 131. In addition, the exhaust gas may be treated in a manner similar to that described above. Specifically, the exhaust gas may be treated with a flame in order to de-energize various components of the exhaust gas, for instance, reactive hydrogen may be oxidized to form water and any particulates, such as soot may be safely oxidized.

System 10 may further include a moving surface, such as belt 14, situated adjacent inlet 13 for collecting and transporting the nanomaterials, i.e., nanotubes, from exit end 114 of synthesis chamber 11. To collect the nanomaterials, belt 14 may be positioned at an angle substantially transverse to the flow of gas carrying the nanomaterials from exit end 114 to permit the nanomaterials to be deposited on to belt 14. In one embodiment, belt 14 may be positioned substantially perpendicularly to the flow of gas and may be porous in nature to allow the flow of gas carrying the nanomaterials to pass therethrough and to exit from the synthesis chamber 11. The flow of gas from the synthesis chamber 11 may, in addition, exit through exhaust 131 in inlet 13. In addition, belt 14, in an embodiment, may be made from a magnetic material, so as to attract the nanomaterials thereonto. For example, where iron nanoparticles may be used as a catalyst to initiate nanomaterial growth, a ferromagnetic material may be used in connection with belt 14 to attract the iron nanoparticles on the nanomaterials onto belt 14.

To carry the nanomaterials away from the inlet 13 of system 10, belt 14 may be designed as a continuous loop similar to a conventional conveyor belt. To that end, belt 14, in an embodiment, may be looped about opposing rotating elements 141 and may be driven by a mechanical device, such as an electric motor 142, in a clockwise manner, as illustrated by arrows 143, so that the belt 14 is moving away from the furnace. Alternatively, a drum (not shown) may be used to provide the moving surface for transporting the nanomaterial. Such a drum may also be driven by a mechanical device, such as electric motor 142. In an embodiment, motors 142 may be controlled through the use of a control system, similar to that used in connection with mechanical drives (not shown), so that tension and velocity can be optimized.

Still looking at FIG. 1, system 10 may include a pressure applicator, such as roller 15, situated adjacent belt 14 to apply a compacting force (i.e., pressure) onto the collected nanomaterials. In particular, as the nanomaterials get transported toward roller 15, the nanomaterials on belt 14 may be forced to move under and against roller 15, such that a pressure may be applied to the intermingled nanomaterials while the nanomaterials get compacted between belt 14 and roller 15 into a coherent substantially-bonded planar-non-woven sheet 16 (see FIG. 2). To enhance the pressure against the nanomaterials on belt 14, a plate 144 may be positioned behind belt 14 to provide a hard surface against which pressure from roller 15 can be applied. Alternatively, pressure may be generated and applied by an “air knife”. Specifically, an inert gas may be used as “air” and may be blown with sufficient pressure onto the nanomaterials on belt 14. It should be noted that the use of roller 15 or an air knife may not be necessary should the collected nanomaterials be ample in amount and sufficiently intermingled, such that an adequate number of contact sites exists to provide the necessary bonding strength to generate the non-woven sheet 16.

To disengage the non-woven sheet 16 of intermingled nanomaterials from belt 14 for subsequent removal from housing 52, a scalpel or blade 17 may be provided downstream of the roller 15 with its edge against surface 145 of belt 14. In this manner, as non-woven sheet 16 moves downstream past roller 15, blade 17 may act to lift the non-woven sheet 16 from surface 145 of belt 14.

Additionally, a spool or roller 18 may be provided downstream of blade 17, so that the disengaged non-woven sheet 16 may subsequently be directed thereonto and wound about roller 18 for harvesting. In an embodiment, roller 18 may be made from a ferromagnetic material to attract the nanomaterials in non-woven sheet 16 thereonto. Of course, other mechanisms may be used, so long as the non-woven sheet 16 can be collected for removal from the housing 52 thereafter. Roller 18, like belt 14, may be driven, in an embodiment, by a mechanical drive, such as an electric motor 181, so that its axis of rotation may be substantially transverse to the direction of movement of the non-woven sheet 16.

In order to minimize bonding of the non-woven sheet 16 to itself as it is being wound about roller 18, a separation material 19 (see FIG. 2) may be applied onto one side of the non-woven sheet 16 prior to the sheet 16 being wound about roller 18. The separation material 19 for use in connection with the present invention may be one of various commercially available metal sheets or polymers that can be supplied, in a continuous roll 191. To that end, the separation material 19 may be pulled along with the non-woven sheet 16 onto roller 18 as sheet 16 is being wound about roller 18. It should be noted that the polymer comprising the separation material 19 may be provided in a sheet, liquid, or any other form, so long as it can be applied to one side of non-woven sheet 16. Moreover, since the intermingled nanotubes within the non-woven sheet 16 may contain catalytic nanoparticles of a ferromagnetic material, such as Fe, Co, Ni, etc., the separation material 19, in one embodiment, may be a non-magnetic material, e.g., conducting or otherwise, so as to prevent the non-woven sheet 16 from sticking strongly to the separation material 19.

Furthermore, system 10 may be provided with a control system (not shown), similar to that in system 10, so that rotation rates of mechanical drives 142 and 181 may be adjusted accordingly. In one embodiment, the control system may be designed to receive data from position sensors, such as optical encoders, attached to each of mechanical drives 142 and 181. Subsequently, based on the data, the control system may use a control algorithm in order to modify power supplied to each drive in order to control the rate of each drive so that they substantially match the rate of nanotube collection on belt 14 to avoid compromising the integrity of the non-woven sheet as it is being wound about the spool. Additionally, the control system can act to synchronize a rate of spin of the roller 18 to that of belt 14. In one embodiment, tension of the non-woven sheet 16 can be reset in real time depending on the velocity values, so that the tension between the belt 14 and roller 18 can be kept within a set value.

The control system can also vary the rate between the roller 18 and belt 14, if necessary, to control the up-take of the non-woven sheet 16 by roller 18. In addition, the control system can cause the roller 18 to adjust slightly back and forth along its axis, so as to permit the non-woven sheet 16 to evenly remain on roller 18.

To the extent desired, an electrostatic field (not shown) may be employed to align the nanotubes, generated from synthesis chamber 11, approximately in a direction of belt motion. The electrostatic field may be generated, in one embodiment, by placing, for instance, two or more electrodes circumferentially about the exit end 114 of synthesis chamber 11 and applying a high voltage to the electrodes. The voltage, in an embodiment, can vary from about 10 V to about 100 kV, and preferably from about 4 kV to about 6 kV. If necessary, the electrodes may be shielded with an insulator, such as a small quartz or other suitable insulator. The presence of the electric field can cause the nanotubes moving therethrough to substantially align with the field, so as to impart an alignment of the nanotubes on moving belt 14.

Alignment of the nanotubes may also be implement through the use of chemical and/or physical processes. For instance, the non-woven nanotubes may be slightly loosened with chemical and physically stretched to substantially align the nanotubes along a desired direction.

In an alternate embodiment, looking now at FIG. 2A, a modified housing for collecting nanomaterials may be used. The modified housing 52 in FIG. 2A may include an inlet 13, through which the nanomaterials enter from the synthesis chamber 11 of system 10, and an outlet 131, through which non-woven sheet 16 may be removed from housing 52. In one embodiment, housing 52 may be designed to be substantially airtight to minimize the release of potentially hazardous airborne particulates from within the synthesis chamber 11 into the environment, and to prevent oxygen from entering into the system 10 and reaching the synthesis chamber 11. In particular, the presence of oxygen within the synthesis chamber 11 can affect the integrity and compromise the production of the nanotubes.

Housing 52 of FIG. 2A may further include an assembly 145 having a moving surface, such as belt 14. As illustrated, belt 14 may be situated adjacent inlet 13 for collecting and transporting the nanomaterials, i.e., nanotubes, exiting from synthesis chamber 11 into the housing 52. In the embodiment shown in FIG. 2A, belt 14, and thus assembly 145, may be situated substantially parallel to the flow of gas carrying the nanomaterials entering into housing 52 through inlet 13, so as to permit the nanomaterials to be deposited on to belt 14. In one embodiment, belt 14 may be made to include a material, such as a magnetic material, capable of attracting the nanomaterials thereonto. The material can vary depending on the catalyst from which the nanotubes are being generated. For example, if the nanomaterials are generated from using a particle of iron catalyst, the magnetic material may be a ferromagnetic material.

To carry the nanomaterials away from the inlet 13 of housing 52, belt 14 may be designed as a substantially continuous loop similar to a conventional conveyor belt. To that end, belt 14, in an embodiment, may be looped about opposing rotating elements 141 and may be driven by a mechanical device, such as rotational gearing 143 driven by a motor located at, for instance, location 142. In addition, belt 14 may be provided with the ability to translate from one side of housing 52 to an opposite side of housing 52 in front of the inlet 13 and in a direction substantially transverse to the flow of nanomaterials through inlet 13. By providing belt 14 with this ability, a relative wide non-woven sheet 16 may be generated on belt 14, that is relatively wider than the flow of nanomaterials into housing 52. To permit belt 14 to translate from side to side, translation gearing 144 may be provided to move assembly 145 on which rollers 141 and belt 14 may be positioned.

Once sufficient nanomaterials have been deposited on belt 14 to provide the non-woven sheet 16 with an appropriate thickness, the non-woven sheet 16 can be removed from housing 52 of FIG. 2A. To remove a non-woven sheet 16, in and embodiment, system 10 may be shut down and the non-woven sheet 16 extracted manually from belt 14 and removed from housing 52 through outlet 131. In order to permit ease of extraction, assembly 145, including the various gears, may be mounted onto a sliding mechanism, such a sliding arms 146, so that assembly 145 may be pulled from housing 52 through outlet 131. Once the non-woven sheet has been extracted, assembly 145 may be pushed back into housing 52 on sliding arms 146. Outlet 131 may then be closed to provide housing 52 with a substantially airtight environment for a subsequent run.

By providing the nanomaterials in a non-woven sheet, the bulk nanomaterials can be easily handled and subsequently processed for end use applications, including hydrogen storage, oxygen storage, high surface area electrodes for supporting a variety of useful particles, or supercapacitor components, among others.

### Example I

Non-woven sheets of carbon nanotubes are created by a CVD process using system 10 shown in FIG. 1. Nanotubes are created in the gas phase and deposited on a moving belt as noted above. A plurality of layers may be necessary to build the non-woven sheet to a density, in an embodiment, of about 1 mg/cm². Density of the non woven sheet can be controlled within a wide range, for instance, from at least about 0.1 mg/cm² to over 5 mg/cm². An example of such a non-woven sheet is shown in FIG. 3 as item 30.

### Electrode Fabrication

Electrodes for a super-capacitor of the present invention, in an embodiment, were initially made by coating a substrate, such as a sheet of aluminum foil, with a substantially uniform layer of a glassy carbon precursor, for example, furfuryl alcohol catalyzed with about 3% malic acid, or with RESOL resin. However, it should be noted that, instead of aluminum foil, a substrate made from other electrically conductive materials may be used. For example, silver, gold, copper, titanium, molybdenum, tunsten, vanadium, other noble metals, graphfoil, semiconductor, graphite, or other intermetallics, including nickel phosphorus or cobalt phosphorus and their alloys, may be used as a substrate material.

A non-woven carbon nanotube sheet was then bonded to the aluminum foil by placing the non-woven sheet on the resin and slowly pyrolyzing the resin at or above about 450° Centigrade or higher to permit the resin material to form a substantially thin glassy carbon bonding layer. It should be appreciated that the temperature at which pyrolysis can be carried out ranges from about 200° C. to about 1500° C. In an embodiment, pyrolysis can be carried out in an inert atmosphere.

### Capacitor Fabrication

In the present invention, a pair of opposing electrodes, made in the manner provided above, may be provided. Thereafter, a porous membrane, such as hydrophilic polypropylene porous membrane, is positioned between the electrodes, and the resulting assembly placed within a non-porous casing. It should be appreciated that other thin separators/membranes may alternatively be placed between the electrodes, so long as the membrane permits diffusion of the electrolyte therethrough. The pair of electrodes may then be secured to and within the casing, for example, by clamping. The casing, in an embodiment, may be made from a non-reactive material, for example, a polymer such as polypropylene, polyethylene, or a combination thereof. The casing may also be sufficiently small and capable of being hand-held, so as to promote portability of the resulting super-capacitor. Once the electrodes and membrane are positioned inside, the joints of the casing were then thermally seals except for a small opening, which may be used for filling the casing with an electrolyte. An electrically conductive contact may also be provided, extending from one of the opposing electrodes through an opening in the casing. However, for high current applications, it may be useful to provide two contacts, each extending from an opposing electrode. To reduce resistance, the contacts may be plated with an electroconductive material, such as gold or silver. The resulting capacitor, in an embodiment, may be used as a portable super-capacitor.

### Organic Electrolyte

A number of commercially useful electrolytes were tested. Typically, acetylnitrile (AN) based electrolytes containing a complex tetraethylammonium tetrafluoroborate provides over a 2.0V breakdown voltage. Other examples include propylene carbonate or its derivatives.

### Inorganic Electrolyte

Inorganic electrolytes may also be used. An example of an inorganic electrolyte that may be used in connection with the present invention may be 6M or 7M aqueous KOH. Alternatively, sulfuric acid solutions or the like may be used.

### Measurements of Capacitance

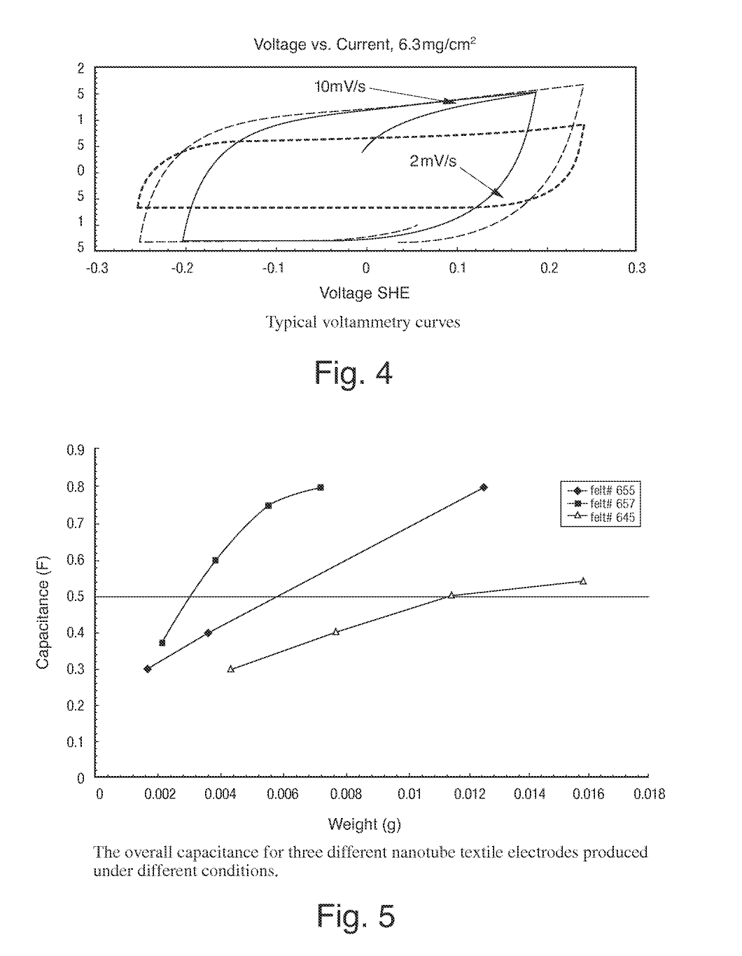

Capacitance of a number of different non-woven sheets of carbon nanotubes were made by scanning voltammetry. An example of a set of voltammetry curves of a single sheet is shown in FIG. 4. In that example, a 6M KOH electrolyte was used and the electrode potential was measured against a standard hydrogen electrolyte (SHE).

It should be noted that as the scan rate increases, the current increases, and capacitance can be directly determined by:

C=i/[dV/dt] (1)

An advantage of this technique is that the voltage range for the electrolyte can be determined, so that substantially minimal or no Faradic reactions occur. In many cases, Faradic reactions would suggest a breakdown of the electrolyte that would reduce the number of charge discharge cycles. Further Faradic reactions may be diffusion controlled, so that the time constant of the capacitor can increase.

Actual variation of overall capacitance with the thickness of the electrode for several different non-woven sheets fabricated under different growth parameters is shown in FIG. 5. As illustrated, clearly one type of non-woven sheet (i.e., sheet #657) is superior to the others. This can be attributed to growth conditions that can produce a superior electrode material. For example, if an electrode is made from the material in sheet #657 for a total capacitance of about 0.5 F, about 25% less of such a material would be necessary, thereby reducing cost and to a lesser extent weight.

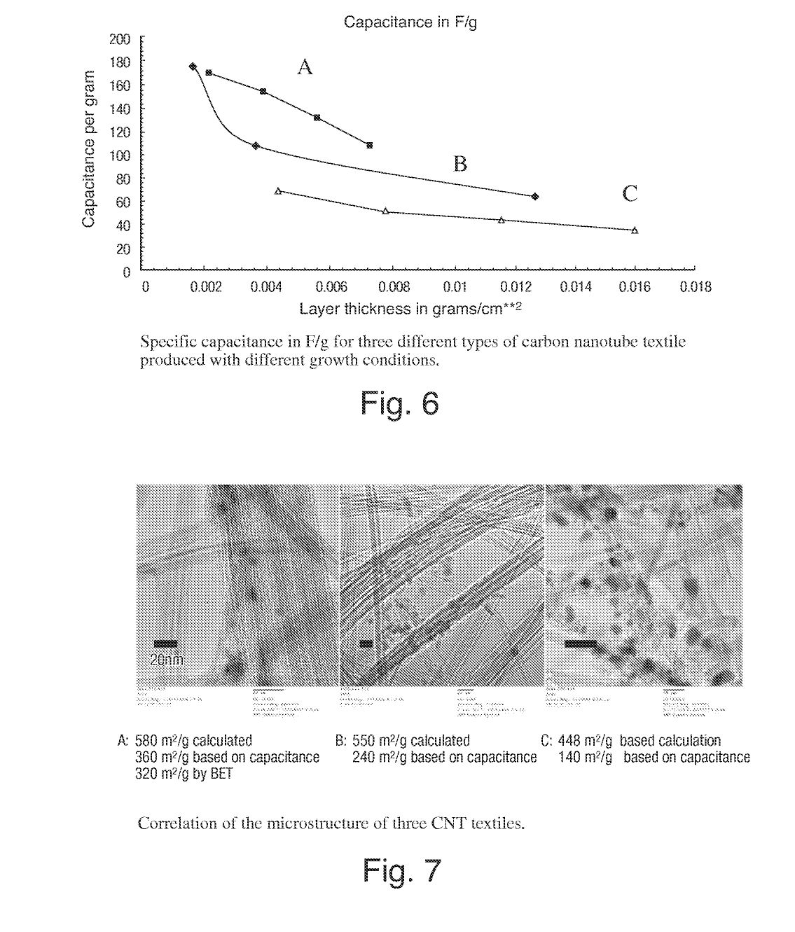

In FIG. 6, the specific capacitance for three different types of non-woven carbon nanotube sheets are shown. These specimens were measured in 6M KOH, therefore, the capacitance might be different in different electrolytes or at different potentials. As illustrated, as the thickness of the electrode material increases, the utilization of the material becomes less efficient, even though the overall capacitance increases. It may be that as the layer increase in thickness, the field penetration is reduced, thereby reducing the double layer capacitance. Comparison with the microstructure for each of these felts is shown in FIGS. 7A-C.

FIGS. 7A-C illustrate a correlation of the microstructure of the three non-woven carbon nanotube sheets shown in FIG. 6 with the surface area. As shown, the highest specific capacitance is exhibited by the smallest tube diameter (FIG. 7A). The highest value of surface area is a specimen showing a preponderance of SWNT fibers, the next specimen has larger SWNT and MWNT, and the last specimen shows much larger carbon nanotubes, even though there are some small tubes. The calculated area, as indicated, is based on a mean diameter, with the measured value using measured capacitance divided by 50 microfarads per cm², a value believed typical for a graphene sheet.

### Example II

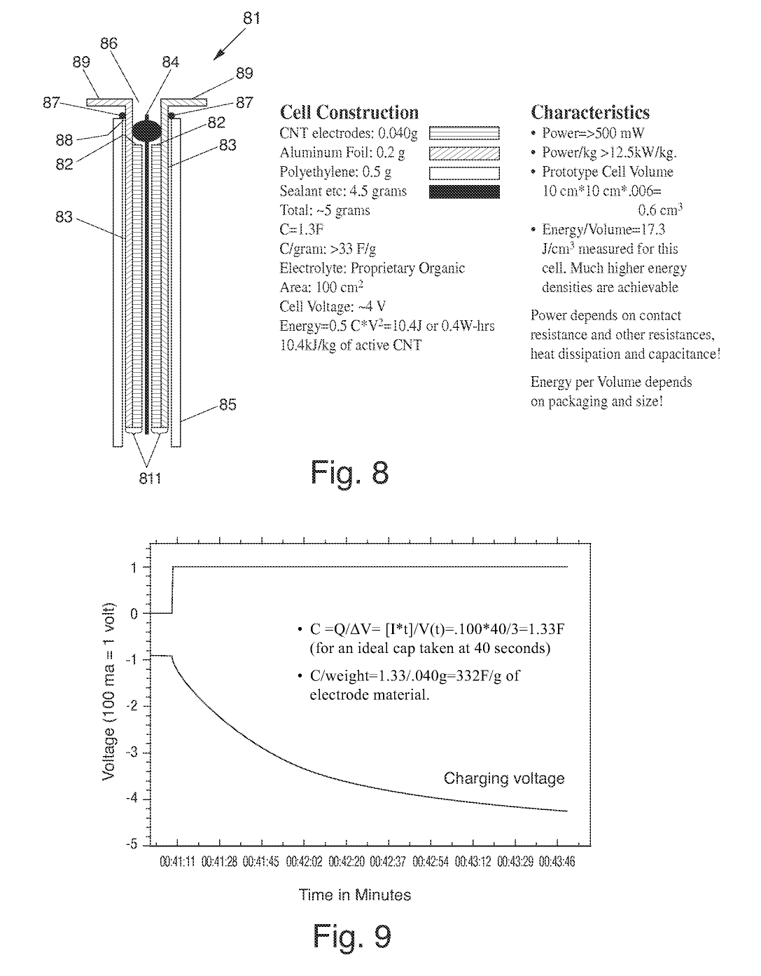

Based on these studies, a material was selected to fabricate a capacitor of the present invention. The design for such a capacitor is illustrated in FIG. 8. In an embodiment, capacitor 81 includes opposing electrodes 811, each made from, among other things, a non-woven carbon nanotube sheet 82. In the embodiment shown in FIG. 8, the non-woven carbon nanotube sheet 82 may weigh about 0.040 grams. Each electrodes 81 may also include a layer of aluminum foil 83 adjacent the non-woven carbon nanotube sheet 82. In an embodiment, the foil 83 may weigh about 0.2 grams. The capacitor 81 may also include a hydrophilic porous polypropylene membrane 84 situated between the opposing electrodes 811. The capacitor 81 further includes an outer polyethylene casing 85 (i.e. package) designed to encapsulate the electrodes 811. In one embodiment, casing 85 may be about 0.5 grams, and may also be made from polypropylene. As shown, the outer polyethylene casing 85 may include an opening 86 for addition of a volume of an electrolyte within the casing. The capacitor 81 further includes a sealant 87 weighing approximately 4.5 grams. In total, as illustrated in FIG. 8, capacitor 81 may have an area of about 100 cm² (e.g., 10 cm×10 cm) and may weigh up to about 5 grams.

In accordance with one embodiment, capacitor 81 may be made by initially providing a pair of electrodes 811, each made by coating an electrically conductive substrate 83, such as aluminum foil, with a glassy carbon precursor material, such as RESOL resin, or malic acid catalyzed (3%) furfuryl alcohol. Next, a nanofibrous non-woven sheets 82 may be placed on the layer of glassy carbon precursor and subsequently bonded to the aluminum foil 83 to form electrode 811. Although aluminum foil is disclosed herein, it should be appreciated that silver foil or other noble metal foils, such as gold or copper can be used. In an embodiment, the bonding step may include slowly pyrolyzing the glassy carbon material at about 450° C. or higher in an inert atmosphere to form a substantially thin glassy carbon bonding layer. Alternatively, pyrolyzation can be carried out in a vacuum. The bonded pieces (i.e., assembly) may thereafter be assembled into a thin film capacitor 81 by placing a hydrophilic polypropylene porous membrane 84 between the electrodes 811, and subsequently securing the pair of electrodes 811 in a non-porous polypropylene or polyethylene casing 85. Joints 88 may subsequently be thermally sealed, while allowing for a small opening 85 for filling the casing with an organic electrolyte, such as an acetylnitrile (AN) based electrolyte. A contact 89 may be provided extending from one of the electrodes 811, and may be coated, for instance, with gold, to reduce contact resistance. For high current or power applications, two contacts 89 may be provided, each extending from one of the electrodes 811. For very high power applications, it is important to minimize contact resistance so that all contracts should be large and may be gold plated.

Capacitor 81, constructed in the manner illustrated in FIG. 8, has, in an embodiment, about 17.3 J/cm³ volumetric energy density, more than about 10.4 kJ/kg mass based density, and about 12.5 kW/kg power density.

The charging current for capacitor 81 is, in an embodiment, illustrated in FIG. 9. An analysis of this charging current yields a capacitance value of about 1.33 F with a specific capacitance being over about 33 F/g for capacitor 81.

It should be appreciated that power can be dependent on contact resistance, heat dissipation, and capacitance, whereas energy per volume is dependent on packaging and size.

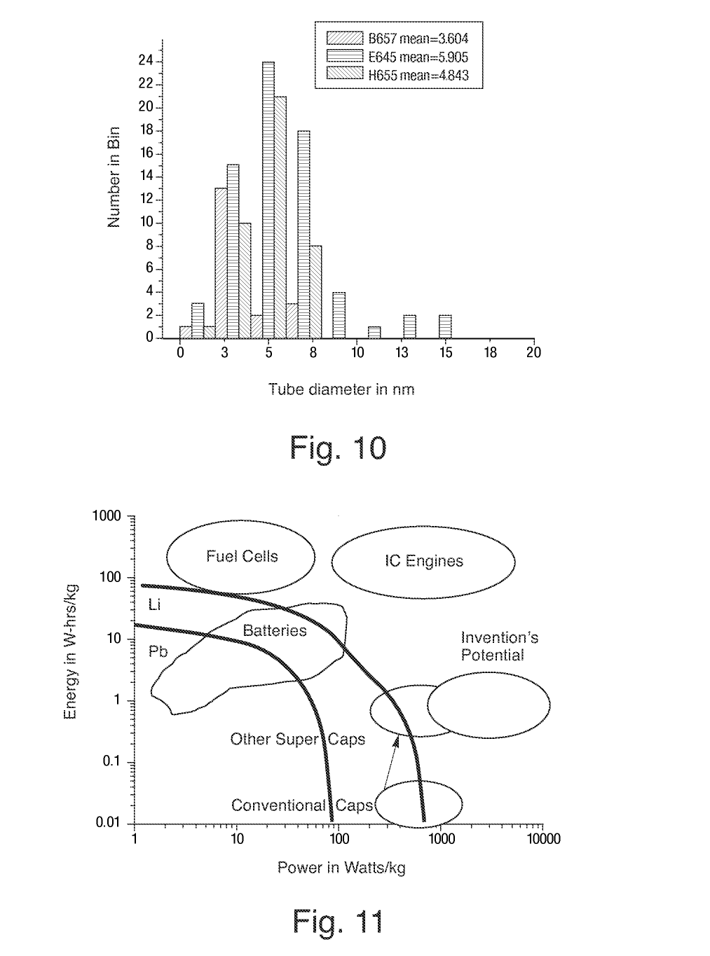

From the results and data indicated above, it appears that the specific capacitance of a capacitor of the present invention, such as capacitor 81, scales inversely with the diameter of the tubes. FIG. 10 illustrates a histogram for the specimens shown in FIG. 5. In particular, for the three types of non-woven carbon nanotube sheets used, it appears that the overall area available for the formation of, for instance, the double layers, is dependent on the type of nanotube present.

An estimate can be made of the actual surface area dependence on tube diameter. For example, for a substantially uniform group of carbon nanotubes of, for instance, 3 nm diameter, the specific surface area with a density of about 1.5 g/cc is about 890 cm²/gram. It is well accepted that the value for the double layer capacitance on an ideal smooth surface may be about 15 microfarads per cm². If it can be assumed that the double layer capacitance on a somewhat defective graphene surface of a nanotube is about 50 microfarads per cm², then the approximate upper limit for carbon nanotube capacitance (under ideal conditions where the tips do not contribute, the catalyst presence is negligible, doping is non-existent, and the defects are not too high), can yield a specific capacitance of about 330 Farads/gram as an upper limit. Similar calculations were done for actual non-woven carbon nanotube sheets using the mean diameters shown in FIG. 10. These results are shown in Table I below.

The measurements of capacitance of CNT textiles in 6 MKOH are lower than in the much higher voltage organic electrolytes. This can attributed to the lower electric field penetration in the former case.

TABLE I
Calculated capacitance based only on the mean
value for the diameter (not the distribution)
along with the measured capacitance.

| | | | Calculated | |
|---|---|---|---|---|
| | | | Capacitance* | |
| | | | F/g | |
| | | Calculated | Based on | Measured |
| | Mean | surface | assumed | Capacitance |
| | Diameter | Area per | 50 μF/cm² for | F/g |
| Sample ID | (nm) | gram (m²) | graphene | in KOH |
| 645 | 5.90 | 450 | 226 | 80 |
| 655 | 4.84 | 550 | 275 | 120 |
| 657 | 3.60 | 740 | 370 | 180 |
| Ideal 3 nm dia | 3 | 889 | 666 | NA |
| Ideal 2 nm dia | 2 | 1333 | 444 | NA |
| Ideal 1 nm dia | 1 | 2997 | 1333 | NA |

It is possible to get much higher specific capacitance values by addition of materials such as RuO or MnO, and/or mesophase carbon. However, the power of the such a capacitor may be affected as power is related to the resistance, both internal and external. In the case where materials which create a pseudocapacitance, such as RuO or MnO, is used, the diffusion process can limit the maximum power. In the case of measophase carbon additions, contact resistance can limit the power.

The advantage of a pure carbon nanotube capacitor, such as the capacitor of the present invention, can be that the energy may be stored within the double layer, and subsequently be rapidly discharged, for instance, in about 40 microseconds, so as to yield a very powerful system. Furthermore, the type of cell illustrated in FIG. 8, can lend itself to the creation of a prismatic capacitor whose voltage can be a simple multiple of the breakdown voltage of a single cell. To that end, an electrochemical capacitor of 1000's of voltages can be created, so that the external resistance of all the circuitry connected to this capacitor becomes less important when engineering high power systems.

As such, construction of a capacitor must take into account not only the specific capacitance but also the internal resistance of the resulting capacitor.

Looking now at FIG. 11, there is illustrated a comparison of the capacitor of the present invention, to commercially available batteries, other capacitors, and internal combustion engines. As shown, there exists a great potential to improve the performance of the capacitor of the present invention by increasing the breakdown voltage of the electrolyte, by optimizing the nature of the nanotube morphology, bond process, and other additives to the electrode, and by increasing the specific capacitance by decreasing the nanotube diameter.

A summary of the measured engineering parameters for capacitor 81 is provided in Table II below.

TABLE II
Capacitor of present invention vs. other capacitors

| Property | Present Invention | Other |
|---|---|---|
| Specific | 180 F/g | 320 F/g (1V) E. Frackowiak et. al., |
| Capacitance | | Journal of Power Sources 153 |
| | | (2006) 413-418 |
| Energy/Volume | 17 J/CC Measured | 3.5 J/CC (TPL, Inc. 3921 |
| | 85 J/CC Estimated | Academy Parkway N.NE |
| | upper limit. | Albuquerque, NM 87109 |
| | Realistic Potential: | Lew Bragg) ONR Program |
| | 60 to 70 J/CC | NO3-T007 for a polypropylene |
| | | type capacitor. |
| Joules/Kg | 12.5 kJ/kg | NA |
| Cost per Farad | ~$0.10/J | $0.20/J (TPL, Inc. 3921 Academy |
| | | Parkway N.NE Albuquerque, |
| | | NM 87109 Lew Bragg) |
| Electrode | 0.02 Ohms/Sq | NA |
| Conductivity | | |

The present invention provides, in an embodiment, a capacitor that can be fabricated using a non-woven sheet of material made from either single wall carbon nanotubes, or multiwall (i.e., dual wall or more) carbon nanotubes, and which can exhibit relatively high electrical conductivity. Interestingly, in the course of testing the non-woven material of the present invention, it was found that single wall carbon nanotube-based non-woven sheets exhibited relatively high specific capacitances in concentrated KOH electrolytes.

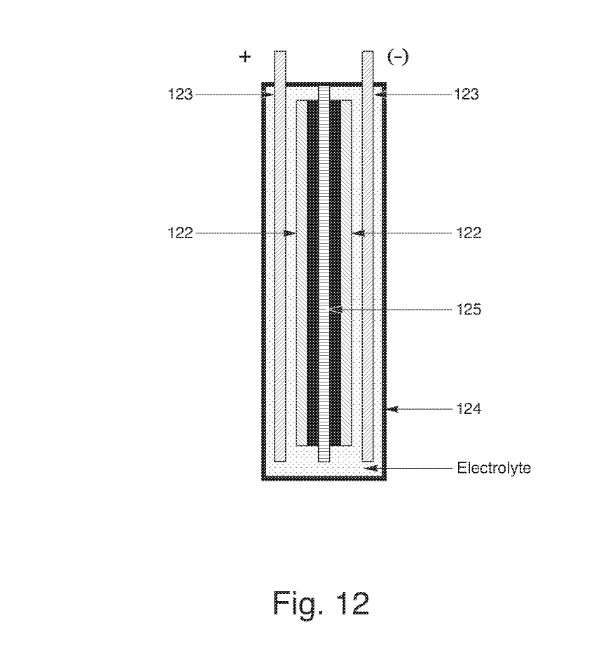

Moreover, although it may be useful to include at least one contact extending from one of the electrodes, it should be appreciated that the capacitor of the present invention can be made to instead have no contacts. In such an embodiment, as illustrated in FIG. 12, capacitor 120 may include opposing electrodes 121 and 122 separated by membrane 125, similar to that in capacitor 81, and at least one additional electrode 123 within casing 124 independent of electrodes 121 and 122. In an embodiment, shown in FIG. 12, a pair of electrodes 123 are provided. Electrode 123 may be designed to have a bipolar effect, such that there appears to be a virtual anode and cathode, and thus no need for a contact to extend from either of the opposing electrodes 121 and 122. Such a bipolar electrode 123 may be commercially available, or may be made in a manner similar to that provided for the opposing electrodes 811 in FIG. 8 (i.e., electrically conductive substrate and a sheet of non-woven nanotubes), and subsequently provided with bipolar properties. It should be appreciated that the design of capacitor 120 may also be employed for a situation where it may be difficult to contact the opposing electrodes 121 and 122.

The present invention further provides, among other things, a process for producing high performance, lightweight electrochemical super-capacitors from non-woven carbon nanotube sheets. In addition, it has demonstrated that the non-woven carbon nanotube sheets can be used to fabricated super-capacitors of very high energy and power densities. A capacitor made from the method of the present invention, as shown above, can have a measured capacitance of about 33 Farads per gram with a demonstrated 17.3 J/cm³ volumetric density, more than 10.4 kJ/kg mass based density, and power densities exceeding 3.5 KJ/Kg. It is expected that these prototype bench marks can be greatly exceeded by reducing nanotube diameter and by improvements in electrolyte.

Further, the relationship between the morphology and the capacitance has been quantitatively described for the first time. Such a relationship, along with the various advantages provided by the carbon nanotube electrodes of the present invention, can pave the way to the manufacture of capacitors at a relatively low cost, with high electrical conductivity, and with ease for scaling-up to industrial volumes.

While the invention has been described in connection with the specific embodiments thereof, it will be understood that it is capable of further modification. Furthermore, this application is intended to cover any variations, uses, or adaptations of the invention, including such departures from the present disclosure as come within known or customary practice in the art to which the invention pertains.

What is claimed is:

1. A capacitor comprising:
opposing substrates of an electrically conductive material;
a non-woven nanotube sheet bonded to each of the opposing substrates;
a casing within which the opposing substrates and the non-woven sheets are situated; and
a contact extending from one opposing substrate through an opening in the casing.

2. A capacitor of claim 1, wherein the substrate is made from one of aluminum, silver, gold, copper, titanium, molybdenum, tunsten, vanadium, other noble metals, graphfoil, semiconductor, graphite, or other intermetallics, including nickel phosphorus or cobalt phosphorus and their alloys.

3. A capacitor of claim 1, wherein the non-woven sheet is made from single wall carbon nanotubes.

4. A capacitor of claim 1, wherein the non-woven sheet is made from multi-wall carbon nanotubes.

5. A capacitor of claim 1, wherein the casing is made from a polymer, including one of polypropylene, polyethylene, or a combination thereof.

6. A capacitor of claim 1, wherein the contact is plated with a material to reduce contact resistance.

7. A capacitor of claim 1, further including a bonding material between each substrate and the non-woven carbon nanotube sheet.

8. A capacitor of claim 7, wherein the bonding material is a glassy carbon material.

9. A capacitor of claim 8, wherein the glassy carbon material is made from precursor including one of Resol resin or malic acid catalyzed furfuryl alcohol.

10. A capacitor of claim 1, wherein the casing is sufficiently small and capable of being hand-held, so as to permit the capacitor to be portable.

11. A capacitor of claim 1, further including a second contact extending from the other opposing substrate.

12. A capacitor of claim 1, further including an electrolyte within the casing.

13. A non-woven carbon nanotube sheet for use in one of hydrogen storage, oxygen storage, high surface area electrodes for supporting a variety of useful particles, or supercapacitor components.

14. A method of manufacturing a capacitor, the method comprising:
bonding a non-woven carbon nanotube sheet to opposing electrically conductive substrates with a glassy carbon precursor to form opposing electrodes;
pyrolyzing the non-woven carbon nanotube sheet to its respective substrate to form a thin glassy carbon bonding layer;
placing the electrodes into a non-porous casing; and
attaching electrically conductive contacts to the electrodes.

15. A method of claim 14, wherein, in the step of bonding, the glassy carbon precursor is one of Resol resin or malic acid catalyzed furfuryl alcohol.

16. A method of claim 14, wherein the step of pyrolyzing includes carrying out the pyrolysis at a temperature range of from about 200° C. to about 1500° C.

17. A method of claim 14, wherein the step of pyrolyzing includes carrying out the pyrolysis in an inert atmosphere or in a vacuum.

18. A method of claim 14, wherein the step of placing includes thermally sealing joints of the casing.

19. A method of claim 14, wherein, in the step of placing, the casing is sufficiently small to permit portability.

20. A method of claim 14, wherein the step of attaching includes coating the contacts with a material that can reduce contact resistance.

21. A capacitor comprising:
opposing substrates of an electrically conductive material;
a non-woven nanotube sheet bonded to each of the opposing substrates to provide opposing electrodes;
at least one bipolar electrode independent of the opposing electrodes; and
a casing within which the opposing substrates and the non-woven sheets are situated.

22. A capacitor of claim 21, further including a glassy carbon bonding material between each substrate and the non-woven carbon nanotube sheet.

23. A capacitor of claim 22, wherein the glassy carbon material is made from precursor including one of Resol resin or malic acid catalyzed furfuryl alcohol.

24. A capacitor of claim 21, further including an electrolyte within the casing.

25. A capacitor of claim 21, wherein the casing is sufficiently small and capable of being hand-held, so as to permit the capacitor to be portable.
